(19) United States
(12) Patent Application Publication
(10) Pub. No.: US 2012/0330959 A1
(43) Pub. Date: Dec. 27, 2012

(54) Method and Apparatus for Assessing a Person's Security Risk

(75) Inventors: Donald R. Kretz, Plano, TX (US); Roderic W. Paulk, Wylie, TX (US)

(73) Assignee: Raytheon Company, Waltham, MA (US)

(21) Appl. No.: 13/169,718

(22) Filed: Jun. 27, 2011

(51) Int. Cl. G06F 17/30

(52) U.S. Cl. 707/739; 707/E17.014; 707/E17.047

(57) ABSTRACT

A method for assessing a person's security risk includes receiving data from a plurality of disparate data sources in which at least two of the plurality of disparate data sources maintain their respective data in different manners. The method also includes identifying at least one item of data from at least two different data sources that correspond to a first real-world person. The method further includes merging the items from the at least two different data sources into a first record associated with the first real-world person. The method additionally includes identifying one or more relationships between the first real-world person and one or more other real-world people. The method also includes adding the identified one or more relationships to the first record associated with the first real-world person. The method further includes determining a level of risk associated with the first real-world person based on the first record.

### BACKGROUND

Every day, millions of people cross international borders by land, air, or sea. A nation's ability to identify and neutralize threats posed by individuals or groups of people (e.g., airline travelers) depends heavily on an accurate and proactive methodology for establishing the person's identity and determining the person's security risk. Typical systems attempting to identify, for example, travelers often confront the problem of multiple distinct or imprecise references to a single real-world person. One conventional approach to risk assessment, such as at airports, is a process known as watch list matching. In watch list matching, passenger travel records are compared against the federal government's consolidated terrorist watch list. Any individuals whose name matches a name on the watch list is flagged for further processing. Although the government watch lists may compile large encyclopedic references derived from multiple data sources, they typically perform match techniques based on exact or approximate comparisons only of names. Methodologies that depend solely on exact or approximate name matches are subject to defeat simply by using aliases, and are typically prone to high levels of false positives.

### SUMMARY

The teachings of the present disclosure relate to methods and apparatuses for assessing a person's security risk. One such method includes receiving data from a plurality of disparate data sources in which at least two of the plurality of disparate data sources maintain their respective data in different manners. The method also includes identifying at least one item of data from at least two different data sources that correspond to a first real-world person. The method further includes merging the at least one item from the at least two different data sources into a first record associated with the first real-world person. The method additionally includes identifying one or more relationships between the first real-world person and one or more other real-world people. The method also includes adding the identified one or more relationships to the first record associated with the first real-world person. The method further includes determining a level of risk associated with the first real-world person based on the first record associated with the first real-world person.

Technical advantages of particular embodiments may include identifying particular people, such as travelers, using information from multiple disparate data sources. This may allow for more accurate identification of people. Another technical advantage of certain embodiments may include enabling the assessment of a person's security risk. Other technical advantages will be readily apparent to one of ordinary skill in the art from the following figures, descriptions, and claims. Moreover, while specific advantages have been enumerated above, various embodiments may include all, some, or none of the enumerated advantages.

### BRIEF DESCRIPTION OF THE FIGURES

For a more complete understanding of particular embodiments and their advantages, reference is now made to the following description, taken in conjunction with the accompanying drawings, in which:

FIG. 1 illustrates a simplified diagram of a system comprising a risk assessment computer coupled to data sources and computers, in accordance with a particular embodiment;

FIG. 2 illustrates a detailed block diagram of a risk assessment computer, in accordance with a particular embodiment; and

FIG. 3 illustrates a method for assessing a person's security risk, in accordance with a particular embodiment.

### DETAILED DESCRIPTION

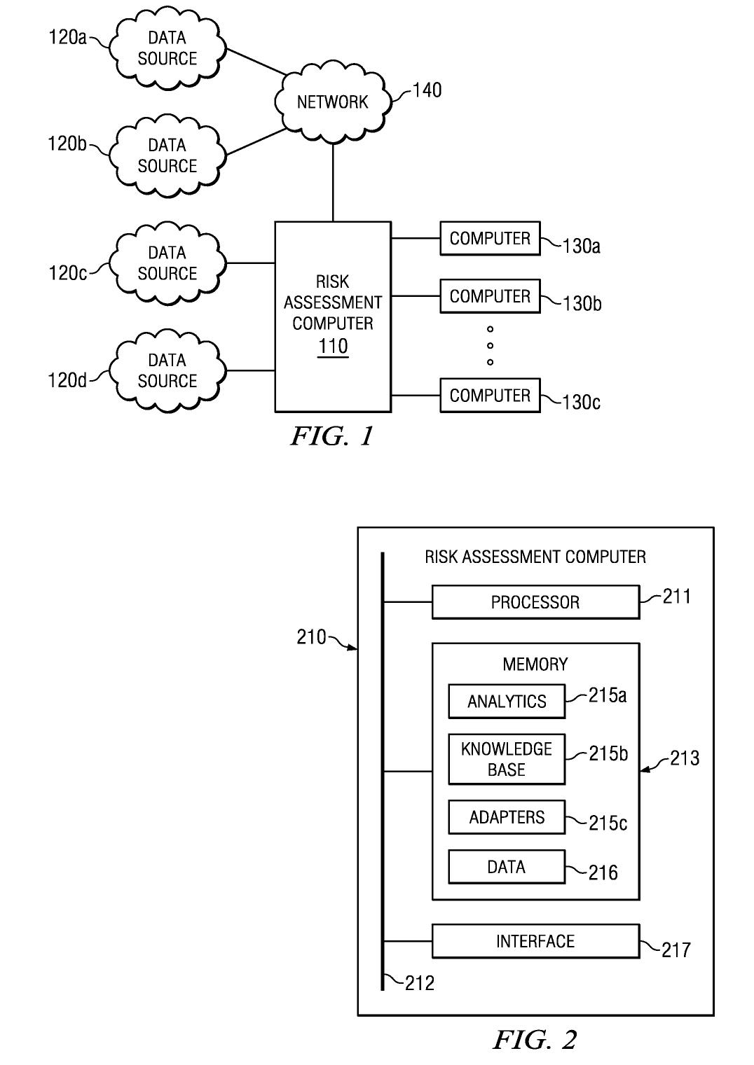

FIG. 1 illustrates a simplified diagram of a risk assessment computer coupled to data sources and computers, in accordance with a particular embodiment. System 100 and RA computer 110 may extend the security screening process beyond traditional watch list matching by generating risk assessments based on the combined data from data sources 120a-120d. In system 100, risk assessment (RA) computer 110 receives data from one or more of data sources 120a-120d (referred to collectively herein as data sources 120). RA computer 110 may attempt to resolve variations, (e.g., formatting, style, and/or arrangement variations) between how the disparate data sources 120 maintain and/or present their data. RA computer 110 may then attempt to merge the data into records associated with actual real-world people. In some instances, RA computer 110 may be able to determine the identity of the actual real-world person. This integrated analysis approach may provides a rich knowledge base for early analysis and recognition of possible threats. Furthermore, in some scenarios it may also provide identification of non-obvious indications of potential risk, particularly those observed for the first time.

Depending on the embodiment or scenario, RA computer 110 may generate a risk assessment for a particular person based on one or more of the person's known familial and social relationships, biographic, biometric, and behavioral information and history prior to making the current risk assessment, and/or any other information collected or determined from data sources 120. The risk assessment may begin with the normalization of the data from data sources 120. This may organize the data according into a consistent format understood by the various matching and/or analyzing algorithms employed by RA computer 110 and/or computers 130.

The received and normalized data may then be condensed by matching and/or merging two or more records from different data sources 120. The merged records may be associated with the same real-world person. In some embodiments, in matching and/or merging user records, RA computer 110 may extract filtered data from the received data, standardize certain attributes or fields, and geo-locate users where the users' profile has a spatial reference. RA computer 110 may then apply a series of map and reduce operations in order to compare entities in a clustered “match and merge” fashion.

In some embodiments, RA computer 110 may distribute the received data, algorithms, and relational similarity measures among one or more of computers 130. This may allow for several algorithms and portions of data to be processed simultaneously by multiple different computers 130. In some instances the data and/or algorithms may be clustered before being distributed to computers 130. Depending on the embodiment, in order for two records to be considered a match, one, some, or all of the algorithms must have identified a match between the two records. Particular embodiments, may also employ recursive matching (e.g., record 3 does not match either record 1 or record 2, but after record 1 and 2 are merged, record 3 matches the merged record). In some embodiments, once the records have been merged, RA computer 110 may then find and represent relationships between the different users. RA computer 110 may also identify patterns in the data, behaviors, and/or relationships of one or more people.

The merged information may provide a good basis for establishing a correlation to a real-world person. Moreover, based on the above information, RA computer 110 may be able to determine the level of risk associated with a particular person. After determining a risk level for one or more people, RA computer 110 may filter the results and construct an output appropriate for review. In some embodiments, the output may have personally identifiable information removed or obfuscated. The output may be published, making it available to interested authorized parties.

Data sources 120 may comprise any of a variety of public data sources 120a and 120b (e.g., social networking websites, forums, blogs, chat rooms, etc.) and private data sources 120c and 120d (e.g., aviation no-fly lists, government watch lists, terrorist lists, communication call graphs, call logs, airline passenger data, wanted lists, etc.). Data sources 120 may also include communication graphs, and biographic histories. Some data received from data sources 120 may include non-textual information (e.g., videos, pictures, audio, etc.). While public data sources 120a and 120b are illustrated as being connected to RA computer 110 through network 140 and private data sources 120c-120d are illustrated as being connected directly to RA computer 110, any data source, whether private or public, may be accessed directly or via one or more networks (e.g., network 140).

The information associated with each user may include information about the user, the user's activities (e.g., travel, interests, etc.), and/or about other users. The data received from data sources 120 may comprise a wide variety of different information types arranged and/or formatted in different ways. Between the disparate data sources 120 there may be a lack of both a common reference model and/or a globally unique identification scheme. For example, depending on the data source, a user may be identified by a screen name, an email address, the user's actual name, or some combination of the above. Furthermore, the data maintained by data sources 120, in particular public data sources 120a and 120b, may be imprecise or ambiguous based on how the respective users entered the information. In some embodiments and/or scenarios RA computer 110 may receive private data from one of the public data sources 120a or 120b. For example, RA computer 110 may receive an email address associated with a profile, the email address may only be viewable by the respective user and/or by the entity running the website with which the profile was created.

Computers 130 may comprise any number of any type of computer running any type of operating system. Computers 130 may be configured to work in parallel to identify matching features between the records extracted by RA computer 110. Computers 130 may use a variety of different algorithms, protocols, rules, and/or schemas to identify matching features between records. Matching features may include identical or similar features. In certain embodiments, matches may be found despite typographical errors. Matches may include temporal and/or spatial (or geographic) features.

Computers 130 may be configured to process vast amounts of data in parallel. The data may be arranged in clusters and different computers 130 may be configured to use different algorithms. This modular framework allows system 100 to add new matching algorithms, new clustering algorithms, new merging algorithms, new risk assessment algorithms, new relationship analysis algorithms, any other desired or suitable algorithms or analytics, additional, different or fewer computers, or any other modification to achieve any desired goal.

In certain embodiments, computers 130 may use conditional operators such as <AND>, <OR>, or <ANY>. For example, <AND> may be used to require that both records being compared contain the same value in each of the specified features. A particular example may comprise birth date <AND> birth-place, in which <AND> may be used to require that in order for two records to be matched, they must both have the same birth date and the same birth place. As another example, <ANY> may be used to require that both records being compared contain the same value in any of the specified features, though not necessarily the same feature. A particular example may comprise work address <ANY> home address, in which <ANY> may be used to require that in order for two records to be a match, they must both have the same address though it does not matter whether it is a home address in one record and a work address in another record. As another example, <OR> may be used to require that both records being compared contain the same value in any of the corresponding fields. A particular example may comprise full_name <OR> social_security_number, in which <OR> may be used to require that in order for two records to be a match, they must include matching full names or matching social security numbers (or both).

In some embodiments, computers 130 may use similarity matching. Similarity matching may match records based on textual or non-textual similarities using user-defined features, comparison algorithms, threshold values, and/or blocking strategies. In certain embodiments, two or more records may be compared to produce a normalized similarity value for each comparison. In particular embodiments, blocking strategies may be used to reduce the number of records that are compared for similarities. For example, a sort comparator may be employed to allows records to be blocked by their Soundex encoding. For example, <sim:first_name,Soundex,Jenny,0.80><AND> last_name may be used to specify that a match occurs if the records being compared match on both first name and last name wherein the match on the last name must be exact while the match on the first name is a similarity comparison using Soundex values (e.g., any of the values “Jenny,” “Jennie,” “Jenney,” or “Jenni” would result in a match against the value of “Jenny”).

In certain embodiments, computers 130 may use spatial similarity. Spatial similarity may match records based on using user-defined features and a grid resolution. For example, geospatial coordinates may be converted into UTM/MGRS grid coordinates of desired resolution for the comparison. Like similarity matching, spatial matching may provide approximate matching functionality in place of exact matching within the same framework of conditional operators.

In some embodiments, temporal similarity matching may be used to match features that are within the same time block. In some embodiments, matching may employ feature sprawl. Feature sprawl may comprise the ability to combine features to be compared as one feature for matching. Feature set matching may comprise the ability to handle mismatched feature naming, such as matching a first name feature from one user and a full name feature from another user. In certain embodiments, once a match has been found, the matching records may be assigned a new entity identifier when merged. In some embodiments, similarity matching, temporal matching, feature set matching, and spatial matching may be treated as extensions to <AND>/<ANY>/<OR> matching.

The distribution of the records among computers 130 may be such that additional computers 130 may be added as the number of records increases or in response to increases in urgency (e.g., to shorten response time to requests for a fused view). For example, in some embodiments the Hadoop framework may be used to allow linear scalability of system 100.

Network 140 may comprise any network or combination of networks capable of transmitting signals, data, and/or messages, including, but not limited to, signals, file transfer protocols, data or messages transmitted through WebPages, e-mail, text chat, voice over IP (VoIP), and instant messaging. Generally, network 140 may provide for the communication of packets, cells, frames, or other portions of information (generally referred to as packets herein) between the various components. Network 140 may comprise one or more private and/or public (e.g., the Internet) networks.

Although a particular scenario is depicted and described with respect to FIG. 1, risk assessments may be generated based on data from any number of data sources, using any number of computers for RA computer 110 and/or computers 130. The components of FIG. 1 may be rearranged or combined, where appropriate. For example, RA computer 110 and its functionality may itself be distributed among computers 130. Moreover, the components depicted in system 100 may vary in different embodiments and/or scenarios from the components discussed above with respect to FIG. 1.

FIG. 2 illustrates a block diagram of a risk assessment computer, in accordance with a particular embodiment. The depicted RA computer 210 may include one or more portions of one or more computer systems. In particular embodiments, one or more of these computer systems may perform one or more steps of one or more methods described or illustrated herein. In particular embodiments, one or more computer systems may provide functionality described or illustrated herein. In some embodiments, encoded software running on one or more computer systems may perform one or more steps of one or more methods described or illustrated herein or provide functionality described or illustrated herein.

The components of RA computer 210 may comprise any suitable physical form, configuration, number, type and/or layout. As an example, and not by way of limitation, RA computer 210 may comprise an embedded computer system, a system-on-chip (SOC), a single-board computer system (SBC) (such as, for example, a computer-on-module (COM) or a system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, RA computer 210 may include one or more computer systems; be unitary or distributed; span multiple locations; span multiple machines; or reside in a cloud, which may include one or more cloud components in one or more networks. In one embodiment, RA computer 210 may be a component of, integrated in, or coupled to, a risk assessment system.

Where appropriate, RA computer 210 may perform without substantial spatial or temporal limitation one or more steps of one or more methods described or illustrated herein. As an example, and not by way of limitation, RA computer 210 may perform in real time or in batch mode one or more steps of one or more methods described or illustrated herein. One or more computers may perform at different times or at different locations one or more steps of one or more methods described or illustrated herein, where appropriate.

In the depicted embodiment, RA computer 210 may include processor 211, memory 213, interface 217, and bus 212. These components may work together to generate one or more risk assessment reports based on data received from multiple disparate data sources. Although a particular computer is depicted as having a particular number of particular components in a particular arrangement, this disclosure contemplates any suitable number of computers of any suitable computer having any suitable number of any suitable components in any suitable arrangement. For simplicity, only the components of RA computer 210 are depicted. Other devices, such as computers 130 or data sources 120 (both depicted in FIG. 1), may be coupled to RA computer 210 (e.g., via interface 217) but are not depicted herein.

Processor 211 may be a microprocessor, controller, or any other suitable computing device, resource, or combination of hardware, software and/or encoded logic operable to provide, either alone or in conjunction with other components (e.g., memory 213), the ability to generate risk assessment reports from data received from different data sources. This functionality may further include providing various other features discussed herein. For example, processor 211 may distribute the extracted records to several computers (e.g., computers 130), running in parallel. Along with distributing the records among the computers, processor 211 may determine and/or distribute one or more rules, protocols, algorithms, and/or schemas that one or more of the computers may use to identify matching records. Processor 211 may also distribute the information and rules used to assess whether a particular person is a security risk.

In particular embodiments, processor 211 may include hardware for executing instructions, such as those making up a computer program. As an example, and not by way of limitation, to execute instructions, processor 211 may retrieve (or fetch) instructions from an internal register, an internal cache, memory 213, or any other data storage device or component; decode and execute them; and then write one or more results to an internal register, an internal cache, memory 213, or any other data storage device or component.

In particular embodiments, processor 211 may include one or more internal caches for data, instructions, or addresses. This disclosure contemplates processor 211 including any suitable number of any suitable internal caches, where appropriate. As an example and not by way of limitation, processor 211 may include one or more instruction caches, one or more data caches, and one or more translation lookaside buffers (TLBs). Instructions in the instruction caches may be copies of instructions in memory 213 or another data storage device or component. The instruction caches may speed up retrieval of those instructions by processor 211. Data in the data caches may be copies of data in memory 213, or another data storage device or component, for instructions executing at processor 211 to operate on; the results of previous instructions executed at processor 211 for access by subsequent instructions executing at processor 211, or for writing to memory 213 or another suitable data storage device or component. The data caches may speed up read or write operations by processor 211. The TLBs may speed up virtual-address translations for processor 211. In particular embodiments, processor 211 may include one or more internal registers for data, instructions, or addresses. Depending on the embodiment, processor 211 may include any suitable number of any suitable internal registers, where appropriate. Where appropriate, processor 211 may include one or more arithmetic logic units (ALUs); be a multi-core processor; include one or more processors 211; or any other suitable processor.

Memory 213 may be any form of volatile or non-volatile memory including, without limitation, magnetic media (e.g., a hard disk drive, a floppy disk drive, magnetic tape), optical media (e.g., an optical disc such as a CD or DVD), random access memory (RAM) (e.g., dynamic RAM (DRAM), static RAM (SRAM), single-ported or multi-ported RAM, or any other suitable type of RAM), read-only memory (ROM) (e.g., mask-programmed ROM, programmable ROM (PROM), erasable PROM (EPROM), electrically erasable PROM (EEPROM), electrically alterable ROM (EAROM), or any other suitable type of ROM), solid-state memory, flash memory, non-removable (or fixed) media, removable media (e.g., Universal Serial Bus (USB) drive), magneto-optical disc, or any other suitable local or remote memory component or combination of components. Memory 213 may include one or more memories 213, where appropriate. In particular embodiments, memory 213 may include mass storage for data or instructions. Memory 213 may be internal or external to RA computer 210, where appropriate. Memory 213 may take any suitable physical form and may comprise any suitable number or type of data storage. In particular embodiments, one or more memory management units (MMUs) may reside between processor 211 and memory 213 and facilitate accesses to memory 213 requested by processor 211.

In certain embodiments, memory 213 may store any suitable data or information utilized by RA computer 210, including software embedded in a computer readable medium, and/or encoded logic incorporated in hardware or otherwise stored (e.g., firmware). In particular embodiments, memory 213 may include main memory for storing instructions for processor 211 to execute or data upon which processor 211 may operate. For example, memory 213 may include analytics 215a for analyzing the extracted records to identify matching records and/or correlate the records to real-world people; knowledge base 215b for storing received data and/or records; and adapters 215c for retrieving and/or normalizing data from the disparate data sources. Memory 213 may also include data 216. Data 216 may include any data used by processor 211. For example, data 216 may comprise temporary data used during one or more calculations.

In certain embodiments, analytics 215a may comprise any logic, algorithms, rules, schemes, policies, standards, or instructions (generally referred to as algorithms) that may be used in matching records, correlating records to actual real-world people, and/or assessing the security risk of the real-world people. In some embodiments, analytics 215a may comprise several independent algorithms. The independent nature of the algorithms may allow an operator to easily add, change, and/or remove any of the algorithms in analytics 215c.

In some embodiments, knowledge base 215b may comprise an ingest store into which the data from the disparate data sources is deposited. In some embodiments, the data may be streamed or retrieved in batches, such as on a periodic or scheduled basis, or the data may be collected continuously. This data may be collected with or without the aid of adapters 215c. For example, the ingest store may be continuously updated with new information from the data sources independent of adapters 215c. Then, periodically, adapters 215c may go through the collected data and normalize it for subsequent processing. As another example, adapters 215c may collect the data and temporarily store it in the ingest store until they have normalized it for subsequent processing. The ingest store may be in a continual state of flux as new data is added from the disparate data sources and removed once it has been normalized and stored in a common format. In certain embodiments, knowledge base 215b may also include a profile base which serves as a repository for merged and unmerged records. The profile base may be continuously growing as new data comes in from new people and/or new information for existing people. In particular embodiments, knowledge base 215b may also include an identity base containing collections of records representing real-world persons and links to their corresponding profiles.

In some embodiments, adapters 215c may be configured to receive data from the disparate data sources. Each data source from which data is received may have its own corresponding adapter 215c configured to receive the data from the data source. For example, one or more adapters may be configured to follow one or more people on a social media site. In addition to being configured to receive data from the disparate data sources, adapters 215c may also be configured to normalize the data. For example, in some instances adapters 215c may manipulate the data from the data sources before it is added to knowledge base 215b. For example, adapter 215c may romanize one or more Chinese characters into a first and/or last name. The manipulation of the data may allow processor 211 to understand the data received from the disparate data sources.

In some embodiments, RA computer 210 may, by way of example and not by way of limitation, load instructions from some data storage component (such as, for example, a server or another computer system) to memory 213. Processor 211 may then load the instructions from memory 213 to an internal register or an internal cache. To execute the instructions, processor 211 may retrieve the instructions from the internal register or internal cache and decode them. During or after execution of the instructions, processor 211 may write one or more results (which may be intermediate or final results) to the internal register or internal cache. Processor 211 may then write one or more of those results to memory 213. In particular embodiments, processor 211 may execute only instructions in one or more internal registers or internal caches or in memory 213 (as opposed to another type of data storage or elsewhere) and may operate only on data in one or more internal registers or internal caches or in memory 213 (as opposed to another type of data storage or elsewhere).

Bus 212 may include any combination of hardware, software embedded in a computer readable medium, and/or encoded logic incorporated in hardware or otherwise stored (e.g., firmware) to couple components of RA computer 210 to each other. As an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 212 may include any number, type, and/or configuration of buses 212, where appropriate. In particular embodiments, one or more buses 212 (which may each include an address bus and a data bus) may couple processor 211 to memory 213. Bus 212 may include one or more memory buses.

In some embodiments, interface 217 may comprise any combination of hardware, encoded software, or a combination of hardware and encoded software configured to receive data and/or user inputs. Where appropriate, interface 217 may include one or more devices or encoded software drivers enabling processor 211 to drive and/or communicate with one or more remote or local devices. Interface 217 may include one or more interfaces 217, where appropriate.

In particular embodiments, interface 217 may include one or more interfaces for one or more I/O devices. One or more of these I/O devices may enable communication between an operator and RA computer 210. As an example and not by way of limitation, an I/O device may include a keyboard, keypad, microphone, monitor, mouse, printer, scanner, speaker, still camera, stylus, tablet, touch screen, trackball, video camera, sensor, another suitable I/O device or a combination of two or more of these. Particular embodiments may include any suitable type and/or number of I/O devices and any suitable type and/or number of interfaces 217 for them. An operator may use one or more of these I/O devices to request and/or view a risk assessment of one or more people.

In certain embodiments, interface 217 may include one or more interfaces for one or more networks or other data sources. Interface 217 may comprise any hardware, connectors, ports, and/or protocols needed to communicate with the respective networks or data sources. For example, interface 217 may comprise a network interface card with an Ethernet port. This may, for example, allow RA computer 210 to connect to the Internet.

Herein, reference to a computer-readable storage medium encompasses one or more tangible, non-transitory, computer-readable storage media possessing structures. As an example, and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a flash memory card, a flash memory drive, or any other suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101.

Particular embodiments may include one or more non-transitory computer-readable storage media implementing any suitable storage. In particular embodiments, a computer-readable storage medium implements one or more portions of processor 211 (such as, for example, one or more internal registers or caches), one or more portions of memory 213, one or more portions of other data storage devices or components, or a combination of these, where appropriate. In particular embodiments, a computer-readable storage medium implements RAM or ROM. In particular embodiments, a computer-readable storage medium implements volatile or persistent memory or data storage. In particular embodiments, one or more computer-readable storage media may embody encoded software.

Herein, reference to encoded software may encompass one or more applications, bytecode, one or more computer programs, one or more executables, one or more instructions, logic, machine code, one or more scripts, or source code, and vice versa, where appropriate, that have been stored or encoded in a computer-readable storage medium. In particular embodiments, encoded software includes one or more application programming interfaces (APIs) stored or encoded in a computer-readable storage medium. Particular embodiments may use any suitable encoded software written or otherwise expressed in any suitable programming language or combination of programming languages stored or encoded in any suitable type or number of computer-readable storage media. In particular embodiments, encoded software may be expressed as source code or object code. In particular embodiments, encoded software is expressed in a higher-level programming language, such as, for example, C, Perl, or a suitable extension thereof. In particular embodiments, encoded software is expressed in a lower-level programming language, such as assembly language (or machine code). In particular embodiments, encoded software is expressed in JAVA. In particular embodiments, encoded software is expressed in Hyper Text Markup Language (HTML), Extensible Markup Language (XML), or other suitable markup language.

Although not depicted, RA computer 210 may be coupled to a network. The term “network” should be interpreted as generally defining any network or combination of networks capable of transmitting signals, data, and/or messages, including, but not limited to, signals, file transfer protocols, data or messages transmitted through WebPages, e-mail, text chat, voice over IP (VoIP), and instant messaging. Generally, the network may provide for the communication of packets, cells, frames, or other portions of information between the various components. In some embodiments, RA computer 210 may connect to one or more data sources and/or one or more computers through one or more networks (e.g., the Internet).

In certain embodiments, system 100 may comprise a modular design in which data sources 120 may be added and removed; matching algorithms may be added, removed, updated, or changed; risk assessment algorithms may be added, removed, updated, or changed; the number and type of computers 130 may be changed; and any other components, features, or functionality may be changed depending on operational needs or desires.

Thus far, several different embodiments and features have been presented. Particular embodiments may combine one or more of these features depending on operational needs and/or component limitations. This may allow for great adaptability of RA computer 210 to the needs of various organizations and users. Some embodiments may include additional or different features. In particular embodiments, the functionality of RA computer 210 may be provided by additional or different devices.

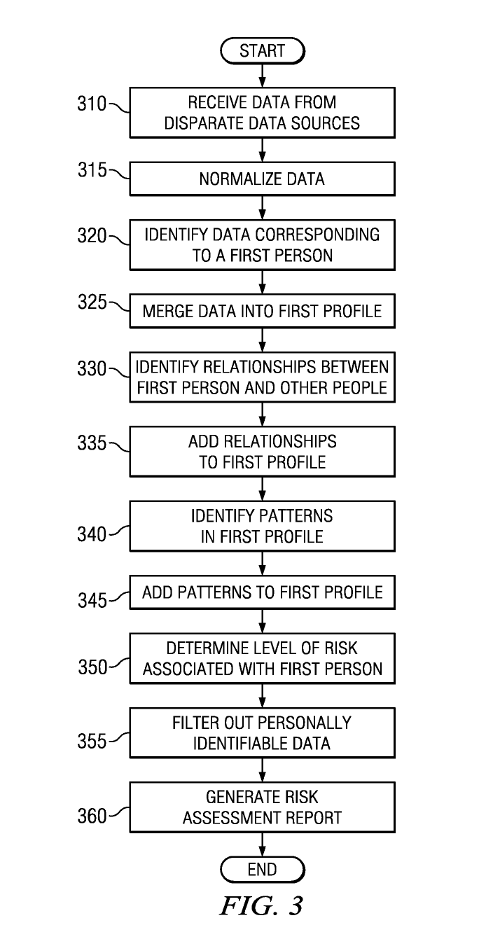

FIG. 3 illustrates a method for assessing a person's security risk, in accordance with a particular embodiment. In certain embodiments, the method of FIG. 3 may be performed by a computer system comprising at least one computer, such as RA computer 210 of FIG. 2. For simplicity of illustration, the method of FIG. 3 may be presented from the perspective of a single RA computer. However, other devices may be used in addition to, or instead of, an RA computer. For example, the RA computer may interface with a storage and computing framework configured to provide large-scale, parallel processing with fast ingest and retrieval. In some embodiments, a clustered comparison technique may be used to distribute and/or divide the processing tasks. In particular embodiments, one or more components or modules (either hardware or encoded logic) used in one or more steps of FIG. 3 may be individual components or modules. The individual components or modules may be added, removed, or changed within the system without impacting the other components or modules of the system. Treating these components or modules as individual components or modules may separate concerns for processing quality (i.e., accuracy, granularity, method of comparison) from system performance (e.g., the number of comparisons to be made, or the number of times the method is invoked). Furthermore, they may allow for targeted optimizations to be performed.

The method begins at step 310 where data from disparate data sources is received. The data may be received via one or more adapters. The received data may be received in any of a variety of different formats. The format of the data may depend on the data source. Because the data sources are disparate, each data source may maintain its data using its own formula, algorithm, technique, protocol, or other way of organizing, managing, streaming, storing, and/or presenting its data. The data may be received by the RA computer (or a device connected thereto). Once received the data may be stored at the RA computer or at an external data storage device coupled to the RA computer.

The disparate data sources may include different and/or separate data sources maintained and/or operated by different business and/or government entities. The data sources may range from public data sources, such as social media websites, to private data sources, such as government watch lists. For example, depending on the scenario and/or embodiment, the disparate data sources may include two or more of the following data sources: social media sites (e.g., Facebook, Linkedin, Twitter, MySpace, etc.), forums, blogs, government watch lists (e.g., wanted lists, terrorist lists, persons of interest lists, no-fly lists, etc.), call logs, call graphs, or any other data source which may include information about real-world people. The received data may include data associated with a plurality of different users, some of the users may have data associated with them at more than one of the disparate data sources. The data may be received and/or collected on a continuous, scheduled, or periodic basis, or upon the occurrence of a triggering event (e.g., an operator request, an update at a social media site, etc.).

In some embodiments, the data sources may organize the data, at a high level, by user profiles. A user profile may refer to a set of data describing a particular person, such as the first person. For example, a Facebook user profile may contain biographic information and social connections associated with the first person, or an employment profile may comprise work history and job skills associated with the first person. When the data is received, the data from each profile from each data source may be organized into records (e.g., one record per user profile). Over time some of the records may merge.

At step 315 the data is normalized. As indicated above, the received data may be arranged and/or formatted in any of a variety of different ways depending on the data source from which it originates. For example, one data source may format a user's name with the first and last name as a single entry, whereas another data source may have the first name and the second name as two separate entries. As another example, one data source may identify its users with a screen name or user ID and another data source may identify its users with an email address. In order to better prepare the data for subsequent processing in steps 320-360, the different arrangements or formats of the received data may be normalized. In some embodiments, normalizing the data may include Romanizing or parsing the data. For example, a person's address may be parsed into different components such as street number, street name, city, county, state, and/or zip code. As another example, a person's name received as a Chinese symbol may be Romanized into the corresponding English name. In some embodiments, normalizing the data may comprise adding geocodes (e.g., unique codes based on predetermined geographical areas), transliterating or translating text, and/or performing any other type of normalization that may be helpful in allowing the different features (or fields) from the different data sources to be compared for possible matches. In some instances, the data may also be cleaned by filtering out garbage entries and/or removing null fields and/or duplicate data.

In some embodiments, records may be extracted from the data received from the disparate data sources before or during normalization. The extracted records may comprise one record for each user profile from each data source. For example, if one data source has three-thousand user profiles and a second data source has five-thousand user profiles, then the system would extract eight-thousand records. Each record may comprise at least one feature associated with the corresponding user profile. The features may include, but are not limited to, screen name, user ID, date of birth, place of birth, real name (e.g., first, last, family, full, etc.), address (e.g., home, work, email, IP, etc.), phone number (e.g., cell phone, home phone, work phone, etc.), location (current location, home location, work location, travel location, city, state, county, country, latitude and longitude, etc.), known acquaintances or relationships (e.g., friends, followers, colleagues, neighbors, etc.), non-textual information (e.g., pictures, maps, audio files or recordings, video clips, etc.), timing information (e.g., when they posted a message, when they went on a trip, etc.), tags or other meta data, data source specific features or items of information, or any other information that may be used to identify or classify either the user or the relationships the user has with other users. Depending on the data source, the feature associated with a piece of information may be explicit (e.g., the data source may have a name field) or the system may have to recognize that a piece of informant is a particular feature (e.g., recognize that a particular string of text is a user name for another user).

In some embodiments, the data may be extracted into a database or table, such as HBase. HBase may comprise a generic table in which each row is associated with a different record and each column is associated with a different feature.

In some embodiments, receiving and normalizing the data from the disparate data sources may be performed by three components or modules. A first component may comprise a Rapid Information Overlay Technology (RIOT). RIOT may provide the framework used to integrate the disparate data sources while reducing the complexity of interfacing with the disparate data sources. RIOT may comprise a simple, elegant, programmatic interface. A second component may comprise a robust distributed index. The distributed index may cross-reference the entities, or users, by their attributes. The tables it creates may be stored across a cluster of computers or servers for better performance. A third component may comprise a collection of core computational analytics. The core analytics may interact with the information overlay to perform a set of standard functions that maintain, extend, or exploit the knowledge space. Furthermore, customized analytics may perform complex domain analysis and derive new knowledge.

In particular embodiments, one or more adapters may be configured to receive and normalize the data from the disparate data sources. In some embodiments, the adapters may collect data while performing little to no checking for the prior existence of the data. In some embodiments, the adapters may perform uniqueness checks against their own data. For example, an adapter for a particular social media site may check to see if a user of the social media site already exists before adding him.

At step 320 data corresponding to a first person is identified. The records containing the data corresponding to the first person may be found by distributing the records and/or matching algorithms to several computers configured to identify matches between the records. In certain embodiments, the records may be distributed in such a way as to allow several computers to work through a large amount of records in a parallel fashion. For example, the records may be organized in clusters. The number of computers to which the records are distributed may vary depending on operational parameters. The computers may be running different matching algorithms or they may be running the same algorithm for different subsets of the records or a combination of the two. In some embodiments, the records may be distributed using the Hadoop framework.

Matching records may be identified based on the likelihood that two or more different records correspond to the same real-world person. That is, it is likely that many real-world users will appear in more than one data source. The computers may be configured to identify the matches based on matching one or more features associated with the different records. The matching algorithms, rules, and/or protocols used to find matches may include any number of techniques for identifying matches despite the features not being exactly the same. In some embodiments, matches may be found where two different words are used to reference the same person, place, or thing. For example, a match may be found between Tom and Tommy or AAC and America Airlines Center. Matches may also be found despite typographical errors.

The first person may be an actual, real-world person. While the first person may be actual real-world person, the system may not necessarily know the actual identity of that first person at this point. The identified data may originate from more than one of the different disparate data sources. For example, data corresponding to a first person may be identified from a social media site as well as from a government watch list. The identified information corresponding to the first person does not necessarily need to be the same from both data sources. For example, identified information corresponding to the first person may comprise the first person's name and home address from one source and the first person's email address and home address from a second source. In some embodiments, data corresponding to the first person may be found by matching one or more items within records from two or more different data sources.

In certain embodiments, data corresponding to the first user may be identified through a series of progressive workflows offering varying levels of pattern complexity. In some embodiments, data received from public sources (e.g., social media, blogs, etc.) in which the information may be inaccurate or may correspond to an anonymous user may be compared to information from private and/or government sources in which the information corresponds to an actual real-world person. The greater the number of correlations performed, the more that is known about the particular individual that can later be analyzed.

In some embodiments, a clustering algorithm (e.g., the Bhattacharya greedy agglomerative clustering algorithm) may be used with a variety of relational similarity measures to cluster the data from the disparate data sources. Once clusters of similar records are formed, pairwise comparisons of the entities inside each cluster may be performed to determine probable matches. In some embodiments, vector comparisons, either literal or approximate (e.g., fuzzy), are performed against the attributes of each of the records (or each of the records within a cluster).

At step 325 the identified data is merged into a first record. The first record may correspond to the first person. For each identified person there may be a different record. The merged data may include the information identified as being associated with a first person. That is, the first record may include the identified information associated with the first person. In this way, the system may accumulate data and/or information for several real-world users in which each record includes data from a number of different disparate data sources. This may provide a convenient way to collect, or gather, all the information about a particular real-world person into a single record. In certain instances the record may be correlated with an actual identity of the corresponding person. In some embodiments, a monotonic merge function may be used to link the matched records to one another in the profile base. This type of merge may, in effect, create a composite identity that consists of the superset of the attributes of all of the associated records.

Any of a variety of different techniques may be used for identifying data corresponding to the same person from two or more of the disparate data sources and then merging the data into a single or common record. In some embodiments, matching multiple references to a single person and merging them may be referred to as identity resolution (also known as entity resolution, co-reference resolution, correspondence, deduplication, etc.).

In some embodiments, merging two or more records may comprise adding a unique identifier, such as a unique record identifier, to the two or more matching records. In particular embodiments, merging two or more records may comprise combining the features from the two records into a new record. Both the matching records and the new merged record may include references to each other or a unique record identifier indicating that they correspond to the same real-world user. In some instances, the merged records may be re-distributed for additional matching. The merged documents may be added and re-compared as many times as needed or specified. For example, in some embodiments the merged records may be added and compared until no additional matches are found. As another example, an operator may specify a fixed number of iterations.

At step 330 relationships between the first person and other people are identified. In some embodiments, the system may identify relationships between users based on the information in the records (merged and unmerged records). Some possible types of relationships include, but are not limited to, employment relationships, school or education based relationships, travel relationships, neighbor or location based relationships, behavior based relationships, communication relationships, or any other relationship which may suggest that two or more users know each other. The relationships may include explicit or obvious relationships, such as where one user is listed as a “friend” of another user. The relationships may include implicit or non-obvious relationships, such as two users who live in the same area and work for the same company. In some embodiments, a certain number of associations may be needed before a relationship is found. The relationships may be identified through any of a variety of different techniques. For example, relationships may be identified based on communications between the first person and one or more other persons. For example, using call records or communication call graphs, the system may identify a relationship between the first person and another person based on the number of calls placed between the two people within a specific period of time. Relationships may also be identified from postings placed on the first person's, or another person's, social media site. Relationships may also be identified based on demographic, socio-economic, travel, or any other type of relationship. For example, the system might identify familial relationships, school friendships, neighborhood friendships, workplace friendships, or any other type of relationship.

At step 335 the identified relationships are added to the first record. In some embodiments, adding relationships may entail linking the first person to the one or more other people with which the first person has a relationship. In particular embodiments, the identified relationships may be added as a feature to the corresponding records of the associated people. In some embodiments, the relationships may be identified and maintained in a separate list of records or as separate records from the records extracted from the disparate data sources. By including relationships within the first person's record, the system may be able to provide a more accurate risk assessment than simply searching the person's user profile for certain keywords (e.g., does the person's blog include “bomb”).

At step 340 patterns are identified in the identified relationships, and then at step 345 the patterns are added to the first record. Although the first person may be described by a rich set of attributes, the resolution quality is greatly improved when the entity's relationships to other people and patterns within those relationships are incorporated in the first record. The system may analyze patterns of relationships, such as patterns in joint travel to particular locations or patterns of communications with particular other users. For example, the extracted records may not include information from which it may be determined that a first user and second user have a relationship, but if the first user and a third user have a relationship and the second user and the third user have a relationship then a pattern may suggest that the first user and the second user have a relationship through the third user. Patterns in travel and/or communication may also be identified. As another example, if a particular person often travels with the first person, and a particular person is a person who the government has identified as a potential security risk, then the pattern of relationship may indicate that the first person may also be a potential security risk. The level of risk may be heightened further if the first person has a pattern of traveling to countries with known terrorist ties.

At step 350 a level of risk associated with the first person is determined. The level of risk may be determined based on all the information that has been added to the first record. This may include the data from the merged records, patterns in the relationships between people, and/or patterns in the other pieces of information within the records. Looking at all this information together, the system may be able to assess the level of risk associated with the first person. Depending on the embodiment or scenario, the level of risk associated with the first person may be determined in response to receiving a request from a particular operator, such as a flight attendant or airport security attendant. In some embodiments, the RA computer may continuously, periodically, or on a scheduled basis, assess the level of risk associated with one or more people.

At step 355 personally identifiable data is filtered out. This may be a way to protect the privacy of people within the system (e.g., non-security risk people). This may prevent the inappropriate use of the information collected, organized, and analyzed by the system. That is, the system may comprise knowledge of the real identities of people by collecting and integrating information from authoritative sources (e.g., driving records, tax records, court records, and/or other government records or data sources).

In certain embodiments, after the personally identifiable data has been filtered out, a risk assessment report may be generated at step 360. The generated risk assessment report may comprise a numerical value indicating the level of risk associated with a particular person. In some embodiments, along with, or in place of, the numerical value there may be provided a list of factors indicating why the risk was as high or as low as it was. The identified factors may be generic in nature such that a reader of the report would not be able to determine any personally identifiable data associated with the respective person. For example, if a particular person is flagged as having a high level of risk based on that person often traveling with another person who is on a government watch list, the risk assessment report may indicate that the particular person is a high risk because he travels with other people with a high risk rather than identify the specific person with which this person travels.

In some embodiments, the steps of FIG. 3 may be performed on a continuous basis to support timely and accurate pre-assessment. In some embodiments, the steps of FIG. 3 may be repeated whenever someone purchases a ticket or boards a vehicle (e.g., plane, train, boat, etc.) that crosses international borders.

While the embodiment depicted in FIG. 3 includes a certain number of steps, depicted in a certain order, it is to be understood that other embodiments may have more, fewer, or different steps, and the steps may be rearranged or performed simultaneously. For example, in some embodiments, relationships and patterns may be identified simultaneously. As another example, the data may be normalized as it is being received.

While various implementations and features are discussed with respect to multiple embodiments, it should be understood that such implementations and features may be combined, re-arranged, or modified in various embodiments. For example, features and functionality discussed with respect to a particular figure, such as FIG. 1, may be used in connection with features and functionality discussed with respect to another such figure, such as FIG. 2 or FIG. 3, according to operational needs or desires. Furthermore, the elements of RA computer 210 may be combined, rearranged or positioned in order to accommodate particular operational needs. In addition, any of these elements may be provided as separate external components to each other where appropriate. Particular embodiments contemplate great flexibility in the arrangement of these elements as well as their internal components.

Numerous other changes, substitutions, variations, alterations and modifications may be ascertained by those skilled in the art and it is intended that the present disclosure encompass all such changes, substitutions, variations, alterations and modifications as falling within the spirit and scope of the appended claims.

What is claimed:

1. A method for risk assessment, comprising:
receiving data from a plurality of disparate data sources wherein at least two of the plurality of disparate data sources maintain their respective data in different manners;
identifying at least one item of data from at least two different data sources that correspond to a first real-world person;
merging the at least one item from the at least two different data sources into a first record associated with the first real-world person;
identifying one or more relationships between the first real-world person and one or more other real-world people;
adding the identified one or more relationships to the first record associated with the first real-world person; and
determining a level of risk associated with the first real-world person based on the first record associated with the first real-world person.

2. The method of claim 1, further comprising generating a risk assessment report for one or more people, the risk assessment report comprising the level of risk associated with at least the first real-world person.

3. The method of claim 2, further comprising filtering out one or more items of personally identifiable data from the risk assessment report.

4. The method of claim 1, further comprising:
identifying one or more patterns in the data in the first record associated with the first real-world person; and
adding the identified one or more patterns to the first record associated with the first real-world person.

5. The method of claim 1, further comprising normalizing the data from the plurality of disparate data sources.

6. The method of claim 1, wherein receiving data from a plurality of disparate data sources comprises receiving data from at least one publicly accessible data source and at least one private data source.

7. The method of claim 1, further comprising determining an identity of the first real-world person.

8. A non-transitory computer readable storage medium comprising logic that when executed is configured to:
receive data from a plurality of disparate data sources wherein at least two of the plurality of disparate data sources maintain their respective data in different manners;
identify at least one item of data from at least two different data sources that correspond to a first real-world person;
merge the at least one item from the at least two different data sources into a first record associated with the first real-world person;
identify one or more relationships between the first real-world person and one or more other real-world people;
add the identified one or more relationships to the first record associated with the first real-world person; and
determine a level of risk associated with the first real-world person based on the first record associated with the first real-world person.

9. The medium of claim 8, wherein the logic is further configured to generate a risk assessment report for one or more people, the risk assessment report comprising the level of risk associated with at least the first real-world person.

10. The medium of claim 9, wherein the logic is further configured to filter out one or more items of personally identifiable data from the risk assessment report.

11. The medium of claim 8, wherein the logic is further configured to:
identify one or more patterns in the data in the first record associated with the first real-world person; and
add the identified one or more patterns to the first record associated with the first real-world person.

12. The medium of claim 8, wherein the logic is further configured to normalize the data from the plurality of disparate data sources.

13. The medium of claim 8, wherein the logic configured to receive data from a plurality of disparate data sources comprises logic configured to receive data from at least one publicly accessible data source and at least one private data source.

14. The medium of claim 8, wherein the logic is further configured to determine an identity of the first real-world person.

15. A system for risk assessment, comprising:
an interface configured to receive data from a plurality of disparate data sources wherein at least two of the plurality of disparate data sources maintain their respective data in different manners; and
a processor coupled to the interface and configured to:
identify at least one item of data from at least two different data sources that correspond to a first real-world person;
merge the at least one item from the at least two different data sources into a first record associated with the first real-world person;
identify one or more relationships between the first real-world person and one or more other real-world people;
add the identified one or more relationships to the first record associated with the first real-world person; and
determine a level of risk associated with the first real-world person based on the first record associated with the first real-world person.

16. The system of claim 15, wherein the processor is further configured to generate a risk assessment report for one or more people, the risk assessment report comprising the level of risk associated with at least the first real-world person.

17. The system of claim 16, wherein the processor is further configured to filter out one or more items of personally identifiable data from the risk assessment report.

18. The system of claim 15, wherein the processor is further configured to:
identify one or more patterns in the data in the first record associated with the first real-world person; and
add the identified one or more patterns to the first record associated with the first real-world person.

19. The system of claim 15, wherein the processor is further configured to normalize the data from the plurality of disparate data sources.

20. The system of claim 15, wherein the interface configured to receive data from a plurality of disparate data sources is further configured to receive data from at least one publicly accessible data source and at least one private data source.

21. The system of claim 15, wherein the processor is further configured to determine an identity of the first real-world person.
